(19) United States
(12) Patent Application Publication
(10) Pub. No.: US 2018/0029488 A1
(43) Pub. Date: Feb. 1, 2018

(54) METHOD AND CONTROL SYSTEM FOR CHARGING A VEHICLE

(71) Applicant: Scania CV AB, Södertälje (SE)

(72) Inventor: Robert SJÖDIN, Nyköping (SE)

(21) Appl. No.: 15/550,387

(22) PCT Filed: Feb. 18, 2016
(86) PCT No.: PCT/SE2016/050124

§ 371 Date: Aug. 11, 2017

(30) Foreign Application Priority Data
Feb. 18, 2015 (SE) 1550176-0

(51) Int. Cl. B60L 11/18

(52) U.S. Cl. CPC B60L 11/1838; B60L 11/1818; B60L 11/1861; B60L 2240/30; B60L 2250/16; B60L 2240/48; B60L 2240/44; B60L 2240/42; Y10S 903/903; B60Y 2200/92; B60Y 2300/91

(57) ABSTRACT

A method for controlling charging of a hybrid vehicle, a control system for charging of a hybrid vehicle and a hybrid vehicle comprising the control system is described. The hybrid vehicle comprises a fuel engine, a parking brake, an electronically controllable operating brake, and a hybrid system comprising a charging unit, an energy storage, and an electric motor system. The control system is connectable to the hybrid system, the fuel engine, the operating brake, and the parking brake. The control system is configured to control the charging of the energy storage in accordance with the charging method. The charging method comprises: detecting connection of a charging cable of an external charging station, ensuring that the hybrid vehicle is ready for charging, and requesting charging from the charging station. Ensuring that the vehicle is ready for charging includes applying the operating brake, also called service brake, of the hybrid vehicle.

### CROSS-REFERENCE TO RELATED APPLICATION(S)

This application is a national stage application (filed under 35 §U.S.C. 371) of PCT/SE16/050124, filed Feb. 18, 2016 of the same title, which, in turn claims priority to Swedish Application No. 1550176-0, filed Feb. 18, 2015 of the same title; the contents of each of which are hereby incorporated by reference.

### FIELD OF THE INVENTION

The invention relates to a method for controlling charging of a hybrid vehicle and a control system for a hybrid vehicle to prevent vehicle drive away or rolling during charging of the batteries of the vehicle.

### BACKGROUND OF THE INVENTION

During charging of the battery of a plug-in hybrid vehicle, or plug-in electric vehicle, it is important that the vehicle remains stationary and does not roll or drive away. This is especially important when a charging cable is connected to the vehicle.

In a normal situation when a plug-in hybrid vehicle should be charged, the driver parks the hybrid vehicle at a charging station, turns off the engine and connects the charging cable to the vehicle by inserting the plug of the charging cable into the charging socket of the hybrid vehicle. The hybrid system and the charging station starts to communicate and the hybrid system requests charging whereby the charging station starts to deliver electrical energy to the battery of the hybrid vehicle.

The driver would normally apply the parking brake when parking the hybrid vehicle. However, the parking brake may malfunction, or the driver may unintentionally release the parking brake by mistake.

US 2010/032018 shows a system and a method wherein the gear box is locked in addition to the parking brake when a hybrid vehicle is charged. However, locking the gear box will only prevent the driving wheels from rolling, and this system will still rely mainly on the parking brake for preventing roll away of the vehicle during charging.

### SUMMARY OF INVENTION

It is an object of the invention to provide a more secure and reliable way of ensuring that the hybrid vehicle remains stationary during the charging.

According to a first aspect, the invention provides a method for controlling charging of a hybrid vehicle, which comprises a fuel engine, an electronic control system, a hybrid system comprising an electric motor, a parking brake and a braking system with an operating brake (also called service brake). The method is performed by the electronic control system of the hybrid vehicle and comprises:

detecting a connection of a charging cable of a charging station;

initiating communication with the charging station;

ensuring that the vehicle is ready for charging, wherein ensuring comprises applying the operating brake of the vehicle; and

requesting charging from the charging station.

Preferably, the method is performed by a hybrid system controller in the electronic control system of the hybrid vehicle.

The ensuring that the vehicle is ready for charging should be performed prior to requesting charging. By applying the operating brake, or service brake, before requesting charging, the hybrid vehicle ensures that it will remain stationary during the following charging.

Normally, the driver will have performed the steps of parking the vehicle, turning off the engine, and applying the parking brake, where after the driver will have connected the hybrid vehicle to a charging station, including inserting a plug of a charging cable into a charging socket of vehicle. The driver may then leave the hybrid vehicle. By applying the operating brake, the hybrid vehicle will remain stationary even if the parking brake malfunctions, or if the driver releases the parking brake by mistake.

Applying the operating brake provides an increased security against movement, especially for larger hybrid vehicles, such as buses or trucks. For large vehicles, such as trucks, the operating brake is a powerful and reliable way to prevent movement, especially for trucks with trailers having individual brakes, of the operating brake, arranged at the wheels of the trailer. A mechanical failure of truck and trailer may go unnoticed by the driver and may impair the braking function of the parking brake. Using an electronically controlled and monitored operating brake of the braking system enhances considerably the reliability of keeping the hybrid vehicle stationary during the charging process.

In an embodiment, the ensuring that the hybrid vehicle is ready for charging includes monitoring the pressure in a pneumatic system that is used to drive the operating brake and determining that the pressure is above a threshold level.

In an embodiment, the method for controlling charging includes monitoring the state of the parking brake and includes detecting that the parking brake is applied.

The hybrid vehicle may have a manual parking brake provided with a state detector connected to the electronic control system of the hybrid vehicle. Alternatively, the parking brake may be an electronic parking brake that can be monitored and actuated by an ECU of the electronic control system, and which electronic parking brake is connected to the electronic control system of the hybrid vehicle, The electronic control system is configured to monitor the electronic parking brake, and may also be configured to actuate the electronic parking brake.

In an embodiment, the method for controlling charging includes monitoring the pressure in a pneumatic system that is used to drive the parking brake and determine that the pressure is appropriate. Especially for parking brakes that are applied by releasing the pressure and emptying the system from air, the electronic control system should determine that the pressure is below a threshold level.

The hybrid vehicle may be equipped with a manually actuated parking brake driven by means of the pneumatic system, or alternatively the hybrid vehicle may be equipped with an electronic parking brake actuated by means of a user interface and/or the electronic control system, and driven by means of the pneumatic system.

In an embodiment, the ensuring that the vehicle is ready for charging includes monitoring the status of the gear box, including determining that the gear box is in the neutral gear. Thereby the fuel engine and the electric motor is not able to drive the wheels even if it is intentionally or unintentionally started during the charging process.

In an embodiment, the method includes locking the gear box in the neutral gear prior to requesting charging. Locking of the gear box in the neutral gear prevents shifting the gear from the neutral gear during the charging.

In an embodiment, the hybrid vehicle is provided with means for securing a charging cable to the vehicle, and the method for controlling charging includes detecting a connection of a charging cable between the charging system and the hybrid vehicle, and locking the charging cable to the hybrid system of the hybrid vehicle.

Preferably, the hybrid controller of the hybrid vehicle is adapted for maneuvering securing means arranged at a charging socket of the hybrid system.

In an embodiment, the steps of ensuring that the vehicle is ready for charging includes determining that the fuel engine of the hybrid vehicle is not running and that the electric motor is disabled. Ensuring that the fuel engine and electric motor is off prevents drive away of the hybrid vehicle during the subsequent charging.

According to a second aspect, the invention provides a control system for a hybrid vehicle comprising:

a hybrid system comprising a charging unit, an energy storage, and an electric motor system;

a fuel engine;

a parking brake; and

an electronically controllable operating brake.

The control system of the second aspect comprises at least one electronic control unit (ECU), wherein the control system:

is operatively connectable to the hybrid system, the fuel engine, and the operating brake;

is configured to monitor the parking brake; and

is configured to control the charging of the energy storage with energy from an external charging station including communicating with the charging station. The control system is also configured to:

detect a connection of a charging cable from the charging station to the charging unit;

initiate communication with the charging station;

ensure that the hybrid vehicle is ready for charging; and

request charging from the charging station.

Especially, the control system is configured to ensure that the hybrid vehicle is ready for charging before requesting charging and is configured to apply the operating brake of the hybrid vehicle in order to ensure that the hybrid vehicle is ready for charging.

In an embodiment, the control system is configured to monitor the pressure in a pneumatic system that is used to drive the operating brake and determine that the pressure is above a threshold level, in order to ensure that the hybrid vehicle is ready for charging.

In an embodiment, the control system is configured to monitor the state of the parking brake and detect that the parking brake is applied, in order to ensure that the hybrid vehicle is ready for charging.

In an embodiment, the control system is configured to monitor the pressure in a pneumatic system that is used to drive the parking brake and determine that the pressure is below a threshold level, in order to ensure that the hybrid vehicle is ready for charging.

In an embodiment, the control system is configured to monitor the status of the gear box, including detecting that the gear box is in the neutral gear, in order to ensure that the hybrid vehicle is ready for charging.

In an embodiment, the control system is configured to lock the gear box in the neutral gear, in order to ensure that the hybrid vehicle is ready for charging.

In an embodiment, the control system is configured to detect a connection of a charging cable between the external charging system and the hybrid vehicle, and lock the charging cable to the hybrid system of the hybrid vehicle, in order to ensure that the hybrid vehicle is ready for charging.

In an embodiment, the control system is configured to determine that the fuel engine is not running and the electric motor is disabled, in order to ensure that the hybrid vehicle is ready for charging.

According to a third aspect, the present invention provides a hybrid vehicle comprising a hybrid system comprising a charging unit, an energy storage, and an electric motor system; a fuel engine, a parking brake, an electronically controllable operating brake and the control system of the second aspect of the invention, which control system is arranged to monitor the parking brake and is operatively connected to the hybrid system, the fuel engine, and the operating brake of the hybrid vehicle.

In an embodiment the hybrid vehicle is a truck or a bus.

According to a fourth aspect, the present invention provides a computer program product comprising a computer program that is loadable into a memory of an electronic control system of a hybrid vehicle, and which computer program upon execution in the electronic control system, for example a hybrid controller of the electronic control system, enables the electronic control system to perform the method of controlling charging of the hybrid vehicle, as described above and as will be further described in the following description of embodiments.

### BRIEF DESCRIPTION OF DRAWINGS

The invention will be described, by way of example, with reference to the accompanying drawings, in which:

FIG. 1 is a schematic illustration of an embodiment of a hybrid vehicle at a charging station, especially illustrating the electronic control of parts of the hybrid vehicle used during charging;

FIG. 2 illustrate some further details of the hybrid vehicle and charging station of FIG. 1; and

FIG. 3 is a schematic flow chart illustrating embodiments of a method of controlling charging of a hybrid vehicle.

### DETAILED DESCRIPTION OF THE INVENTION

The invention will in the following be described with reference to the accompanying drawings, in which certain embodiments of the invention are illustrated. The invention may however be embodied in many different forms and should not be construed as limited to the embodiments; rather, these embodiments are provided by way of example in order to facilitate in making the invention.

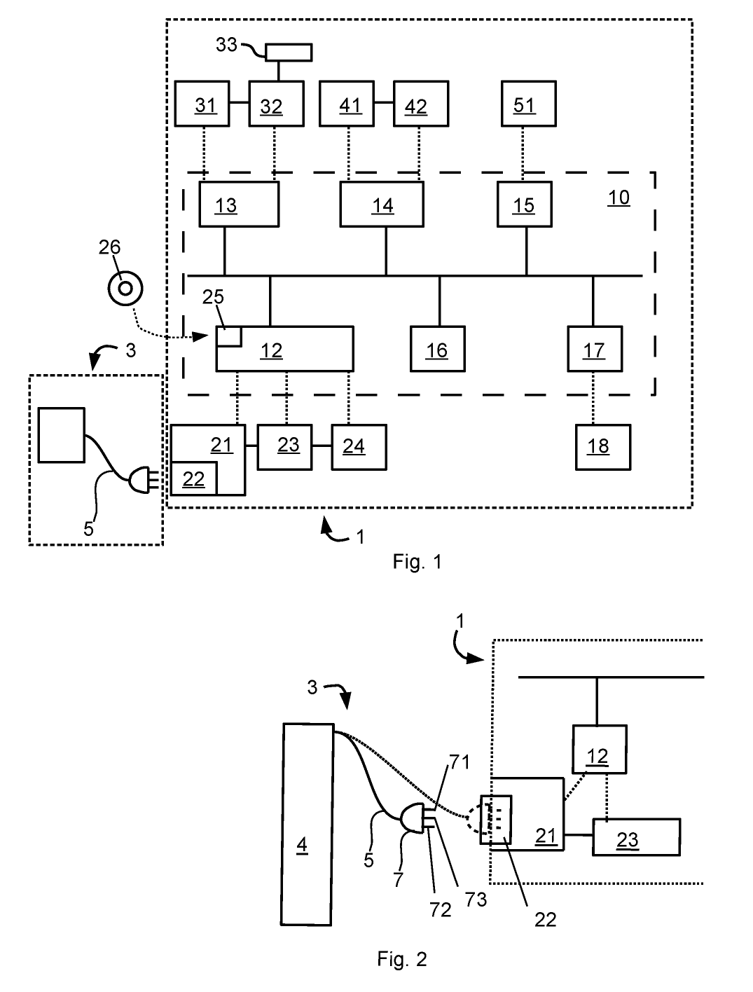

FIG. 1 is an overview of parts of a control system 10 of a hybrid vehicle 1, such as comprising a CAN communication network, and comprising a plurality of control units 12-17, such as ECU (Electronic Control Units), each control unit 12-17 comprising communication means. The control system 10 of the invention comprises at least one electronic control unit, it is however preferable to arrange a plurality of electronic control units in a network. The control units are communicatively interconnected and includes a hybrid controller 12, a braking system controller 13, a parking brake controller 14, a gear box controller 15, a user interface 16 and an engine control system 17. The hybrid vehicle 1 is positioned adjacent a charging station 3 in order to charge the hybrid vehicle 1 by means of a charging cable 5 of the charging station 3, which charging cable 5 is adapted for transferring electrical energy to, and provide communication with, the hybrid vehicle 1. The control system 10 is configured for controlling charging of the hybrid vehicle 1 and in the illustrated embodiment the charging is controlled by the hybrid controller 12. The hybrid vehicle 1 is for example a car, or a larger vehicle such as a bus or a truck.

Each control unit 12-17 is configured to control respective units of the hybrid vehicle 1 and in the following features relevant for describing the invention will be described in more detail, although FIG. 1 as such is a simplified illustration of a control system 10 and a hybrid vehicle 1.

The hybrid controller 12 is operatively connected to a charging unit 21, a battery system or energy storage 23 and an electric motor system 24. The hybrid controller 12 is configured to monitor and control the charging unit 21 during charging of the vehicle including detecting connection of a charging cable 5 to a cable connector socket 22 of the charging unit 21. The hybrid controller 12 is configured to request charging of the hybrid vehicle 1 from a charging station 3 that is connected to the charging unit 21. The hybrid controller 12 is also configured to monitor the charging level of the battery system or energy storage 23. The hybrid controller 12 is further configured to control the electric motor 24 including disabling the electric motor 24 and determine that the electric motor 24 is disabled.

The braking system controller 13 is configured to monitor the status of an operating, or service, brake 32 of the vehicle 1 and is configured to operatively control the applying of the operating brake 32. The braking system controller 13 is also configured to monitor the status of a driving system of the operating brake 32, which is a pneumatic system 31, that is used to maneuver the operating brake 32, which monitoring includes determining the functioning of the driving system, including ensuring that the pressure in the pneumatic system 31 is above a threshold level ensuring proper maneuvering of the operating brake 32. The operating brake 32 is also controllable by means of a foot pedal 33 of the hybrid vehicle 1. The electronic control system 10, especially the hybrid controller 12, is configured to control the charging process and is configured to apply the operating brake 32 preferably by means of the hybrid controller 12 transferring a command to the braking system controller 13 to apply the operating brake 32.

The parking brake controller 14 is connected to the parking brake system and configured to monitor the status of the parking brake 42. Preferably, the parking brake 42 is manually activated and pneumatically driven by means of a pneumatic drive system 41. The parking brake controller 14 is configured to monitor the state of the parking brake 42 and the pneumatic drive system 41 is arranged to drive the parking brake 42 upon manual activation. However, it is not necessary nor preferable to electronically maneuver the parking brake 42 by means of the parking brake controller 14. The parking brake controller 14 and the parking brake 42 may be configured and arranged to allow maneuvering of the parking brake 42 electronically by means of the parking brake controller 14 being operatively connected to an electronic parking brake 42.

The gear box controller 15 is operatively connected to the gear box 51 and is configured to monitor the status of the gear box 51, especially which gear is active. It is suitable to configure the hybrid controller 12 to only allow charging when the gear box 51 is in neutral. The gear box controller 15 is configured to lock and select gear, especially configured to apply the neutral gear, and is configured to lock or select gear when receiving a command from, for example, the hybrid controller 12 that indicates that the gear box 51 should be locked or switched to neutral. The gear box controller 15 may also be controlled by means of parts of the user interface 16, such as by gear selectors at the steering wheel (not illustrated).

The user interface 16 is configured to receive user input from the driver, such as the driver turning on and off a main fuel engine 18, such as a diesel, an ethanol or a gas engine, or the driver stopping charging of the hybrid vehicle 1.

The engine control system 17 is configured to monitor the status of the fuel engine 18 being on or off, and is operatively configured to start and stop the fuel engine 18 upon receiving user input indicating starting and stopping, respectively.

In order to control the charging process of the hybrid vehicle 1, the hybrid controller 12 of the electronic control system 10 is configured to monitor the status of the parking brake 42, the gear box 51, the fuel engine 18 and the electric motor 24.

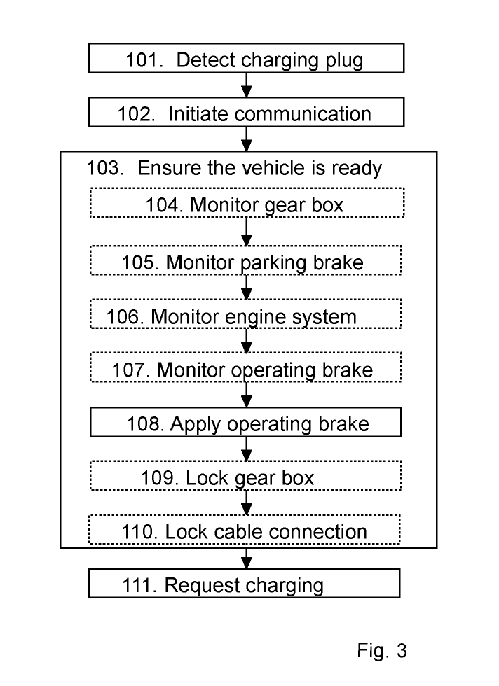

FIG. 1 also illustrates a computer program product 25, illustrated as a computer disc, which computer program product comprises a data carrier having a computer program stored thereon. The data carrier may be any non-transitory entity or device capable of carrying the program. For example, the data carrier may comprise a storage medium, such as a Flash memory, a ROM (Read Only Memory), for example a DVD (Digital Video/Versatile Disk), a CD (Compact Disc) or a semiconductor ROM, an EPROM (Erasable Programmable Read-Only Memory), an EEPROM (Electrically Erasable Programmable Read-Only Memory), or a magnetic recording medium, for example a floppy disc or hard disc. Alternatively, the carrier may be an integrated circuit in which the program is embedded, the integrated circuit being adapted for performing, or for use in the performance of, the relevant processes. The computer program is adapted for loading into a memory 26 of the electronic control system 10, and the computer program comprises software configured to be executed in the electronic control system 10 of the hybrid vehicle 1. The computer program is adapted to enable the electronic control system 10 to perform its functions, and especially the method steps described with reference to FIG. 3 in the following description of embodiments of a method, when executed by the electronic control system 10.

FIG. 2 illustrate a suitable connection between the hybrid vehicle 1 and a charging station 3. The charging station 3 comprises a supply unit 4 for supplying electrical energy to the hybrid vehicle 1. The supply unit 4 has the outer form of a pole, which is secured to the ground and remains stationary during charging. The supply unit 4 is connected to an electrical power system (not illustrated). The charging station 3 further comprises a charging cable 5 provided with a charging plug 7 provided for insertion into a hybrid vehicle 1. The charging cable 5 and charging plug 7 provides a movable link between the supply unit 4 and the hybrid vehicle 1 and is provided to transfer the electrical energy to the energy storage 23 of the hybrid vehicle 1.

The hybrid vehicle 1 comprises a charging unit 21 provided with a charging cable socket 22 configured for receiving the charging plug 7 of the charging station 3. As in FIG. 1, the illustrated hybrid vehicle 1 also comprises a hybrid controller 12 and an energy storage 23 that comprises electric batteries. The energy storage 23 is provided with an electrical connection to the charging unit 21, and the hybrid vehicle 1 is configured to receive electrical energy by means of the charging unit 21, which energy is stored in the energy storage 23. The hybrid controller 12 is adapted for controlling and monitoring the charging unit 21 and the energy storage 23, and especially to control the charging process.

The charging plug 7 of the charging station 3 comprises a number of contact pins, exemplified as three contact pins 71-73. The number of contact pins may be chosen differently. The three contact pins 71-73 are configured to provide three functions. The charging cable socket 22 of the hybrid vehicle 1 is provided with corresponding contacts in order to establish a connection with the contact pins 71-73 of the charging station 3.

A first contact pin 71 is a presence indicating pin, which is arranged to indicate a presence of the charging plug 7 in the hybrid vehicle 1 when the charging plug 7 is inserted into the charging socket 22 of the hybrid vehicle 1. The hybrid controller 12 is configured to detect the presence of a charging plug 7 in the charging cable socket 22 of the charging unit 21.

A second contact pin 72 is arranged to provide contact for a communication interface between the charging station 3 and the hybrid controller 12 of the hybrid vehicle 1. Upon insertion of the charging plug 7 in the socket of the hybrid vehicle 1, the hybrid vehicle 1 is configured to detect the presence of the charging plug 7, and to initiate a communication session with the charging station 3 by means of the hybrid controller 12 via the charging unit 21 and the connection between the second contact pin 72 and the corresponding contact of the charging cable socket 22. The hybrid controller 12 is adapted to register a connection of a charging plug 7 and to register that communication with a charging station 3 has been established. The hybrid controller 12 is configured to perform a handshaking session with the charging station 3 upon connection of the charging cable 5.

The third contact pin 73 of the charging station 3 is provided for the transfer of the electrical energy to the energy storage 23, via the charging unit 21 and the corresponding contact of the socket 22 of the charging unit 21. The hybrid controller 12 is configured to request charging, by means of the communication interface including the second contact pin 72, from the charging station 3 when the hybrid vehicle 1 is ready for charging, and subsequently receive electric energy from the charging station 3 by means of the third contact pin 73.

The hybrid vehicle 1, especially the hybrid controller 12, is configured to ensure that the hybrid vehicle 1 is ready to be charged and to request charging by means of the communication interface, wherein the charging station 3 starts the supply of electrical energy. Thus, the hybrid vehicle 1 is configured to:

receive the charging plug 7 and detect the presence of the charging plug 7 in the charging cable socket 22;

establish communication with the charging station 3;

ensure that the hybrid vehicle 1 is ready for charging;

request charging from the charging station 3; and

store the received electrical energy in the energy storage 23.

FIG. 3 illustrates embodiments of the method of controlling charging of a hybrid vehicle 1 according to the invention. In a representative scenario before the hybrid vehicle 1 performs the charging control, a driver of the hybrid vehicle 1 parks the hybrid vehicle 1 at a charging station 3, sets the gear box 51 in neutral, turns off the engine 18, sets the parking brake 42, and inserts the charging plug 7 of the charging station 3 into the charging socket 22 of the hybrid vehicle 1.

The illustrated embodiment of the charging control method is performed by electronic control system 10 of the hybrid vehicle 1, especially the hybrid controller 12, and may suitable be provided as a software program that when run on a hybrid controller 12, or other computer control unit such as an ECU, of the hybrid vehicle 1, makes the hybrid vehicle 1 perform the method. The method for controlling charging starts with detecting 101 the presence of the charging plug 7 in the charging socket 22. The hybrid controller 12 is configured to register the presence of the charging plug 7 upon detection during the insertion, and sets a connection state indicator in a memory 25 of the electronic control system 10 of the hybrid vehicle 1 to indicate that a charging plug 7 is connected.

The method continues with initiating 102 communication with the charging station 3, wherein a handshaking process is performed between the hybrid vehicle 1 and the charging station 3. The initiation 102 may include verification of the charging station 3 and of the hybrid vehicle 1, using e.g. exchange of password, electronic identification or encryption keys. The hybrid controller 12 is configured to register a successfully initiated communication and sets a communication state indicator to indicate that communication with a charging station 3 commence and is available.

The method further includes ensuring 103 that the hybrid vehicle 1 is ready to be charged. The ensuring 103 that the hybrid vehicle 1 is ready for charging includes applying 108 the operating brake 32, wherein the electronic control system 10 of the hybrid vehicle 1 applies the operating, or service, brake 32 of the hybrid vehicle 1. Preferably, the applying 108 of the operating brake 32 is performed by means of the hybrid controller 12 transferring a command to the braking system controller 13 that applies the operating brakes 32 of the hybrid vehicle 1.

After ensuring 103 that the hybrid vehicle 1 is ready for charging, the method continues with requesting 111 charging from the charging station 3. The charging station 3 responds by starting to supply electrical energy to the hybrid vehicle 1, which receives and stores the delivered energy in the energy storage 23.

The ensuring 103 that the vehicle is ready for charging suitable also includes a number of sub-steps illustrated in FIG. 3. For example, in addition to the step of applying 108 the operating brake 32, the ensuring 103 may include monitoring 107 the braking system including ensuring that the brake driving system functions properly. Each sub-step provides criteria that the electronic control system 10, preferably the hybrid controller 12, is configured to check. The illustrated sub-steps include monitoring 104 the state of the gear box 51, monitoring 105 the state of the parking brake 42, determining 106 that the fuel engine 18 is not running and that electric motor 24 is not running, monitoring 107 the braking system, locking 109 the gear box 51 in neutral, and locking 110 the cable connection 5 to the hybrid vehicle 1. All of which sub-steps is performed prior to requesting 111 charging.

The monitoring 104 of the state of the gear box 51 includes determining that the gear box 51 is in neutral. It is suitable to include the criteria that the gear box 51 should be in the neutral gear so that the wheels cannot be driven by the hybrid vehicle fuel engine 18 or electric motor 24.

The monitoring 105 of the parking brake 42 includes determining that the parking brake 42 is applied. The monitoring 105 of the parking brake 42 also includes monitoring the pressure of the pneumatic driving system 41 of the parking brake 42 and determining that the pneumatic pressure is below a threshold level.

The monitoring 106 of the engine system 17 and the electric motor 24 comprises checking that the fuel engine 18, such as a diesel engine, is turned off, or not running and that the electric motor 24 is disabled.

The monitoring 107 of the braking system comprises ensuring that the brake driving system functions properly including ensuring that the pneumatic system 31 that drives the operating brake 32 has a pressure above an operating threshold. The monitoring 107 of the operating brake 32 and/or pneumatic system 31 may continue during the subsequent charging process.

The locking 109 of the gear box includes locking the gear box 51 in neutral, which ensures that if the engine is started, the gear box 51 cannot be shifted from the neutral, ensuring that the motor will not drive the wheels.

Locking 110 the cable connection includes for example applying an electronically controlled securing pin (not shown) that locks the charging plug 7 to the charging socket 22.

A method for controlling charging of a hybrid vehicle 1, an electronic control system 10 for charging of a hybrid vehicle 1 and a hybrid vehicle 1 comprising the control system 10 has been described. The hybrid vehicle 1 comprises a fuel engine 18, a parking brake 42, an electronically controllable operating brake 32, also called service brake 32, and a hybrid system. The hybrid system comprises a charging unit 21, an energy storage 23, and an electric motor system 24. The control system 10, and is connectable, or connected, to the hybrid system, the fuel engine 18, the operating brake 32, and the parking brake 42. The control system 10 is configured to control the charging of the energy storage 23 in accordance with the charging method.

The charging method comprises:

detecting 101 connection of a charging cable 5 of an external charging station 3;

ensuring 103 that the hybrid vehicle 1 is ready for charging, wherein ensuring comprises applying the operating brake of the vehicle; and

requesting 111 charging from the charging station 3.

The inventive concept is also applicable for controlling charging of a battery electric vehicle, BEV, with electric energy from a charging station, which vehicle comprises an electronic control system, a drive system comprising at least one electric motor and an energy storage, a parking brake and an electronically controllable operating brake, said control of charging being performed by the electronic control system and comprising:

detecting (101) connection of a charging cable (5) of the charging station (3);

initiating (102) communication with the charging station (3);

ensuring (103) that the battery electric vehicle is ready for charging, wherein ensuring comprises applying the operating brake (32) of the vehicle; and

requesting (111) charging from the charging station (3).

The inventive concept is also applicable to a corresponding control system for a battery electric vehicle. The inventive concept is also applicable to a battery vehicle comprising such a control system. The inventive concept is also applicable to a computer program product, which computer program product comprises software, stored on a data carrier, that when executed by an electronic control system of a battery electric vehicle enables the electronic control system to perform the method for controlling charging of a battery electric vehicle according to the above.

1. The method for controlling charging of a hybrid vehicle with electric energy from a charging station, which vehicle comprises a fuel engine, an electronic control system, a hybrid system comprising at least one electric motor and an energy storage and an electronically controllable operating brake, said method being performed by the electronic control system and comprising:
detecting connection of a charging cable of the charging station;
initiating communication with the charging station;
ensuring that the hybrid vehicle is ready for charging, wherein ensuring comprises applying the operating brake of the vehicle; and
requesting charging from the charging station.

2. The method for controlling charging according to claim 1, wherein the ensuring that the hybrid vehicle is ready for charging comprises monitoring the pressure in a pneumatic system that is used to drive the operating brake and determining that the pressure is above a threshold level.

3. The method for controlling charging according to claim 1, wherein the ensuring that the hybrid vehicle is ready for charging comprises:
monitoring the state of the parking brake and detecting that the parking brake is applied.

4. The method for controlling charging according to claim 3, the ensuring that the hybrid vehicle is ready for charging comprises monitoring the pressure in a pneumatic system that is used to drive the parking brake and determine that the pressure is below a threshold level.

5. The method for controlling charging according to claim 1, wherein the ensuring that the vehicle is ready for charging comprises monitoring the status of the gear box, which comprises detecting that the gear box is in neutral gear.

6. The method for controlling charging according to claim 5, including:
locking the gear box in the neutral gear prior to requesting charging.

7. The method for controlling charging according to claim 1 comprises:
detecting a connection of a charging cable between the charging system and the hybrid vehicle; and
locking the charging cable to the hybrid system of the hybrid vehicle.

8. The method for controlling charging according to claim 1, wherein the ensuring that the vehicle is ready for charging comprises determining that the fuel engine is not running and that the electric motor is disabled.

9. A control system for a hybrid vehicle, which hybrid vehicle comprises a hybrid system comprising a charging unit, an energy storage, and an electric motor system; a fuel engine (18), a parking brake (42) and an electronically controllable operating brake, which control system comprises at least one electronic control unit, wherein the control system is operatively connectable to the hybrid system, the fuel engine, and the operating brake, is configured to monitor the parking brake and is configured to control the charging of the energy storage with energy from a charging station including communicating with the charging station, wherein the control system is configured to:
detect a connection of a charging cable from the charging station to the charging unit;
ensure that the hybrid vehicle is ready for charging by applying the operating brake of the hybrid vehicle; and
request charging from the charging station.

10. The control system for a hybrid vehicle according to claim 9, wherein, to ensure that the hybrid vehicle is ready for charging, the control system is configured to monitor the pressure in a pneumatic system that is used to drive the operating brake and determine that the pressure is above a threshold level.

11. The control system for a hybrid vehicle according to claim 9, wherein, to ensure that the hybrid vehicle is ready for charging, the control system is configured to monitor the state of the parking brake and detect that the parking brake is applied.

12. The control system for a hybrid vehicle according to claim 11, wherein, to ensure that the hybrid vehicle is ready for charging, the control system is configured to monitor the pressure in a pneumatic system that is used to drive the parking brake and determine that the pressure is below a threshold level.

13. The control system for a hybrid vehicle according to claim 9, wherein, to ensure that the hybrid vehicle is ready for charging, the control system is configured to monitor the status of the gear box, including detecting that the gear box is in the neutral gear.

14. The control system for a hybrid vehicle according to claim 13, wherein, to ensure that the hybrid vehicle is ready for charging, the control system is configured to lock the gear box in the neutral gear.

15. The control system for a hybrid vehicle according to claim 9, wherein, to ensure that the hybrid vehicle is ready for charging, the control system is configured to detect a connection of a charging cable between the charging system and the hybrid vehicle, and
locking the charging cable to the hybrid vehicle.

16. The control system for a hybrid vehicle according to claim 9, wherein, to ensure that the hybrid vehicle is ready for charging, the control system is configured to determine that the fuel engine is not running and that the electric motor is disabled.

17. A hybrid vehicle comprising:
a hybrid system comprising a charging unit, an energy storage, and an electric motor system;
a fuel engine;
a parking brake;
an electronically controllable operating brake; and
a control system arranged to monitor the parking brake and is operatively connected to the hybrid system, the fuel engine, and the operating brake of the hybrid vehicle, wherein the control system is configured to:
detect a connection of a charging cable from the charging station to the charging unit;
ensure that the hybrid vehicle is ready for charging by applying the operating brake of the hybrid vehicle; and
request charging from the charging station.

18. A computer program product comprising computer program code stored in a non-transitory computer-readable medium readable by a computer, said computer program product used for controlling charging of a hybrid vehicle with electric energy from a charging station, which vehicle comprises a fuel engine, an electronic control system, a hybrid system comprising at least one electric motor and an energy storage, a parking brake and an electronically controllable operating brake, said computer program code comprising computer instructions to cause one or more computer processors to perform the following operations:
detecting connection of a charging cable of the charging station;
initiating communication with the charging station;
ensuring that the hybrid vehicle is ready for charging, wherein ensuring comprises applying the operating brake of the vehicle; and
requesting charging from the charging station.
